(19) United States
(12) Patent Application Publication
(10) Pub. No.: US 2025/0035940 A1
(43) Pub. Date: Jan. 30, 2025

(54) OPTICAL SCANNER WITH MULTI-PASS OPTICAL RELAY

(71) Applicant: GOOGLE LLC, Mountain View, CA (US)

(72) Inventors: Daniel Adema, Kitchener (CA); Ian Andrews, Kitchener (CA)

(21) Appl. No.: 18/713,998

(22) PCT Filed: Nov. 21, 2022
(86) PCT No.: PCT/US2022/050610

§ 371 Date: May 28, 2024

Related U.S. Application Data
(60) Provisional application No. 63/284,232, filed on Nov. 30, 2021.

(51) Int. Cl. G02B 27/01

(52) U.S. Cl. CPC G02B 27/0176; G02B 27/0172; G02B 2027/0154

(57) ABSTRACT

A WHUD includes an optical scanner having two scan mirrors and a multi-pass optical relay. The first scan mirror receives light emitted from an optical engine representative of one or more images. The first scan mirror oscillates in a first direction such that the received light is scanned in a first direction and provides the light scanned in the first direction to a multi-pass optical relay. The multi-pass optical relay then relays the light to a second scan mirror. The second scan mirror is configured to oscillate in a second direction such that the relayed light is scanned in both the first and second directions. The second scan mirror then provides the light scanned in the first and second directions back to the multi-pass optical relay which relays the light scanned in the first and second directions to an incoupler of a waveguide.

### BACKGROUND

Within wearable heads-up displays (WHUDs), light emitted from optical engines is provided to the eyes of a user to confer an image to the user. To achieve this aim, some WHUDs implement one or more waveguides to direct and transform the light from the optical engine to the eyes of the user. For example, such WHUDs use waveguides that include exit pupil expanders that increase the number of exit pupils of the light from the optical engine before it is provided to the eyes of the user and outcouplers that provide the light to the eyes of the user. To provide the light emitted from an optical engine to a waveguide, many WHUDs have optical scanners that include scanning mirrors to scan received light in one or more directions and optical relays to relay the scanned light within or out of the optical scanner. However, optical scanners configured to scan received light in two or more directions are large in size, leading to an increase in the size of the form factor of the WHUD, which negatively impacts user experience. Additionally, optical scanners configured to scan received light in two or more directions can introduce pupil walk in the light output by the optical scanner.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an example display system housing a laser projector system configured to project images toward the eye of a user, in accordance with some embodiments.

FIG. 2 is a diagram illustrating a laser projection system having an optical scanner, in accordance with some embodiments.

FIG. 3 is a diagram illustrating an optical scanner having scanning mirrors and a multi-pass optical relay, in accordance with some embodiments.

FIGS. 4 to 8 each respectively show a diagram illustrating an example multi-pass optical relay, in accordance with some embodiments.

FIG. 9 is a diagram illustrating a waveguide having an incoupler, outcoupler, and exit pupil expander, in accordance with some embodiments.

FIG. 10 is a diagram illustrating a partially transparent view of a wearable heads-up display (WHUD) that includes a laser projection system, in accordance with some embodiments.

### SUMMARY OF EMBODIMENTS

Techniques and systems described herein are directed to an optical scanner having a multi-pass optical relay. According to an example embodiment an optical scanner for a wearable heads-up display includes a first scan mirror configured to scan received light in a first direction and a second scan mirror configured to scan received light in a second direction. Additionally, the optical scanner can include a multi-pass optical relay configured to relay light scanned in the first direction from the first scan mirror to the second scan mirror and configured to relay light scanned in the first and second directions from the second scan mirror to an incoupler of a waveguide.

In embodiments, the optical scanner can also include a polarizing beam splitter configured to reflect light having a first predetermined polarization toward the multi-pass optical relay and configured to transmit light having a second predetermined polarization toward the incoupler of the waveguide. Further, the light scanned in the first direction may have a first predetermined polarization. Also, the optical scanner can include a quarter-wave plate configured to polarize the light scanned in the first and second directions such that the light scanned in the first and second directions has a second predetermined polarization. The first predetermined polarization can be perpendicular to the second predetermined polarization. Further, the quarter-wave plate can be disposed in an optical path between the multi-pass optical relay and the second scan mirror, an optical path between the multi-pass optical relay and the second scan mirror, or an optical path between the first scan mirror and the multi-pass optical relay. Additionally, the quarter-wave plate may be disposed in the multi-pass optical relay.

The multi-pass optical relay can include a fold mirror configured to reflect light from a first lens of the multi-pass optical relay to a second lens of the multi-pass optical relay. Also, the multi-pass optical relay can include a 4F relay or reflective relay. Additionally, the first scan mirror may include a first micro-electro-mechanical systems (MEMS) mirror configured to oscillate in the first direction and the second scan mirror may include a second MEMS mirror configured to oscillate in the second direction.

In another example embodiment, a wearable heads-up display (WHUD) includes an optical engine configured to emit laser light. Further, the WHUD can include an optical scanner configured to scan the laser light in a first direction and a second direction and an incoupler of a waveguide configured to receive the laser light scanned in the first and second directions. The optical scanner may include a first scan mirror configured to scan the laser light in the first direction and a second scan mirror configured to scan the laser light in the second direction. Further, the optical scanner can include a multi-pass optical relay configured to relay the laser light scanned in the first direction from the first scan mirror to the second scan mirror and configured to relay the laser light scanned in the first and second directions from the second scan mirror to the incoupler.

According to embodiments, the WHUD can include an arm configured to carry the optical engine and the optical scanner. Further, the WHUD can include a polarizing beam splitter configured to transmit laser light having a first predetermined polarization toward the multi-pass optical relay and configured to reflect light having a second predetermined polarization toward the incoupler of the waveguide.

In embodiments, the laser light scanned in the first direction may have a first predetermined polarization. The WHUD can also include a quarter-wave plate configured to polarize the light scanned in the first and second directions such that the light scanned in the first and second directions has a second predetermined polarization. The first predetermined polarization may be perpendicular to the second predetermined polarization. The quarter-wave plate can be disposed in an optical path between the multi-pass optical relay and the second scan mirror or an optical path between the first scan mirror and the multi-pass optical relay. Also, the quarter-wave plate can be disposed in the multi-pass optical relay. The multi-pass optical relay can include a 4F relay or a reflective relay.

As another example, a method includes scanning, by a first scan mirror, laser light in a first direction. Further, the method can include relaying, by a multi-pass optical relay, laser light scanned in the first direction from the first scan mirror to a second scan mirror. Additionally, the method may include scanning, by the second scan mirror, laser light in a second direction and providing, by the multi-pass optical relay, laser light scanned in the first and second directions to an incoupler of a waveguide.

In embodiments, the method can also include emitting, by an optical engine, the laser light toward the first scan mirror. Further, the method can include polarizing laser light received by the first scan mirror such that the laser light received by the first scan mirror has a first predetermined polarization. Additionally, the method can include reflecting, by a polarizing beam splitter, at least a portion of the laser light scanned in the first direction having the first predetermined polarization toward the multi-pass optical relay. Also, the method can include polarizing, by a quarter-wave plate, laser light scanned in the first and second directions such that the laser light scanned in the first and second directions has a second predetermined polarization perpendicular to the first predetermined polarization. The method can also include transmitting, by the polarizing beam splitter, at least a portion of the laser light scanned in the first and second directions having the second predetermined polarization toward the incoupler. Further, the method can include providing, by the waveguide, at least a portion of the light laser light scanned in the first and second directions to a lens of an optical combiner.

### DETAILED DESCRIPTION

Some WHUDs are designed to look like eyeglasses, with at least one of the lenses containing a waveguide to direct light to a user's eye. The combination of the lens and waveguide is referred to as an “optical combiner”. Such waveguides form, for example, exit pupil expanders (EPEs) and outcouplers that form and guide light to the user's eye. The WHUD generally has a frame designed to be worn in front of a user's eyes to allow the user to view both their environment and computer-generated content projected from the combiner. Components which are necessary to the functioning of a typical WHUD, such as, for example, an optical engine to project computer-generated content (e.g., light representative of one or more images), cameras to pinpoint physical location, cameras to track the movement of the user's eye(s), processors to power the optical engine, and a power supply, are typically housed within the frame of the WHUD. As a WHUD frame has limited volume in which to accommodate these components, it is desirable that these components be as small as possible and configured to interact with the other components in very small volumes of space.

In order to provide images to the user of a WHUD, the WHUD includes an optical scanner configured to provide light from an optical engine to a waveguide. Such an optical scanner, for example, is configured to scan received light in two or more directions (e.g., along two or more axes) and relay the scanned light to the incoupler of a waveguide. To scan received light in two or more directions, some optical scanners include one or more scan mirrors (e.g., micro-electro-mechanical systems (MEMS) mirrors) configured to oscillate in two directions (2-dimensional (2D) mirrors) so as to scan received light in those directions (e.g., in two directions). However, such optical scanners including 2-D mirrors (e.g., scan mirrors configured to oscillate in two or more directions) are large in size, increasing the form factor of the WHUD and making it difficult for the WHUD to achieve the form factor and fashion appeal expected of eyeglasses and sunglasses. Further, to scan received light in two or more directions, other optical scanners include two or more scan mirrors (e.g., MEMS mirrors) configured to oscillate in one direction (e.g., 1-dimensional (1D) mirrors) and two or more optical relays to respectively relay the light between the scan mirrors and to the incoupler of a waveguide. For example, such optical scanners include a first optical relay configured to relay light scanned from a first 1-D scan mirror to a second 1-D scan mirror and a second optical relay configured to relay light from the second 1-D scan mirror to the incoupler of the waveguide. However, due to the physical separation of the 1-D scan mirrors, the pupil position of the scanned light along a first axis is different from the pupil position along one or more other axes. Such a difference in the pupil position of the scanned light along a first axis and the pupil position along one or more other axes is also referred to herein as a “pupil walk” in the scanned light. The difference in the pupil position along the axes of the scanned light (e.g., pupil walk in the scanned light) results in the scanned light having a rectangular or oval shape when it is provided to the incoupler of the waveguide.

As such, systems and techniques disclosed herein are directed to reducing the size of an optical scanner configured to scan light in two or more directions without introducing pupil walk. To this end, a WHUD includes an optical scanner having two 1D scan mirrors (e.g., 1D MEMS mirrors) and a multi-pass optical relay. The multi-pass optical relay is configured to both relay light from a first 1D scan mirror to a second 1D scan mirror and relay light from the second 1D scan mirror to an incoupler of a waveguide. For example, the optical scanner includes a first 1D scan mirror (e.g., MEMS mirror) configured to receive light emitted from an optical engine representative of one or more images. The first 1D scan mirror is configured to oscillate in a first direction (e.g., along a first axis) such that the received light is scanned in a first direction. The first 1D scan mirror then provides the light scanned in the first direction to a multi-pass optical relay configured to relay the light to a second 1-D scan mirror (e.g., MEMS mirror). The second 1-D scan mirror is configured to oscillate in a second direction (e.g., along a second axis) such that the relayed light is scanned in both the first and second directions. The second 1D scan mirror then provides the light scanned in the first and second directions back to the multi-pass optical relay which relays the light scanned in the first and second directions to an incoupler of a waveguide. To relay the light scanned in the first and second directions from the multi-pass relay to an incoupler of a waveguide, the optical scanner also includes a polarizing beam splitter or prism deposed between the first 1-D scan mirror and the multi-pass optical relay and configured to direct the light scanned in the first and second directions from the multi-pass relay to the incoupler of a waveguide. For example, the optical scanner includes a waveplate (e.g., quarter-wave plate) configured to polarize light within the optical scanner such that the light scanned in the first and second directions relayed by the multi-pass optical relay has a polarization causing it to be reflected by a polarizing beam splitter (PBS) towards the incoupler of a waveguide. In this way, an optical scanner including a multi-pass optical relay helps reduce the size of the optical scanner while helping to reduce pupil walk. As such, a WHUD including the optical scanner better achieves the form factor and fashion appeal expected of eyeglasses and sunglasses

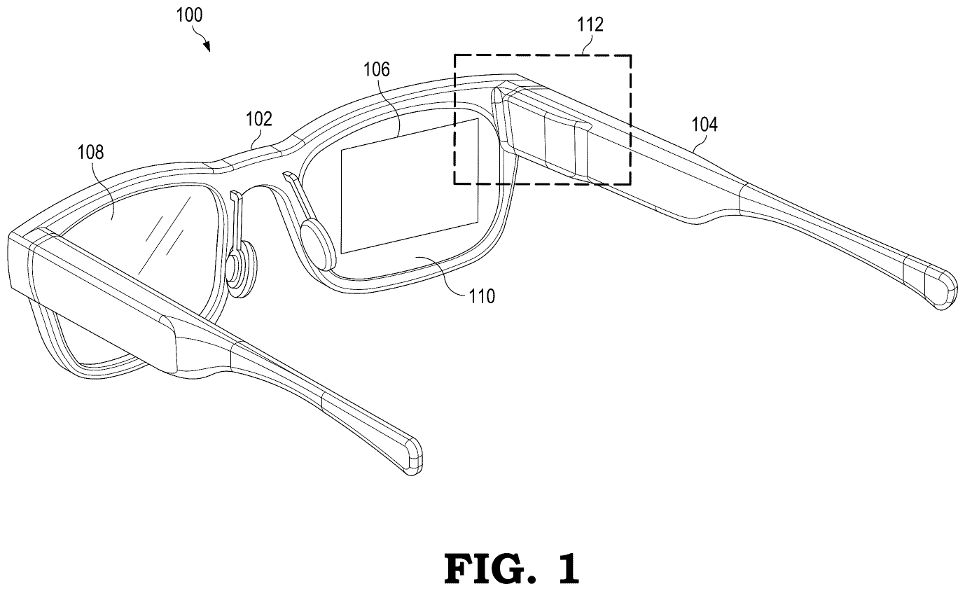

FIG. 1 illustrates an example display system 100 having a support structure 102 that includes an arm 104, which houses a laser projection system configured to project images toward the eye of a user, such that the user perceives the projected images as being displayed in a field of view (FOV) area 106 of a display at one or both of lens elements 108, 110. In the depicted embodiment, the display system 100 is a wearable heads-up display (WHUD) that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a laser projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth(™) interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be MEMS-based or piezo-based. The projector is communicatively coupled to the controller and a non-transitory processor-readable storage medium or a memory that stores processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, a multi-pass optical relay disposed between the first and second scan mirrors, and a waveguide disposed at the output of the second scan mirror. In some embodiments, at least a portion of an outcoupler of the waveguide may overlap the FOV area 106. These aspects are described in greater detail below.

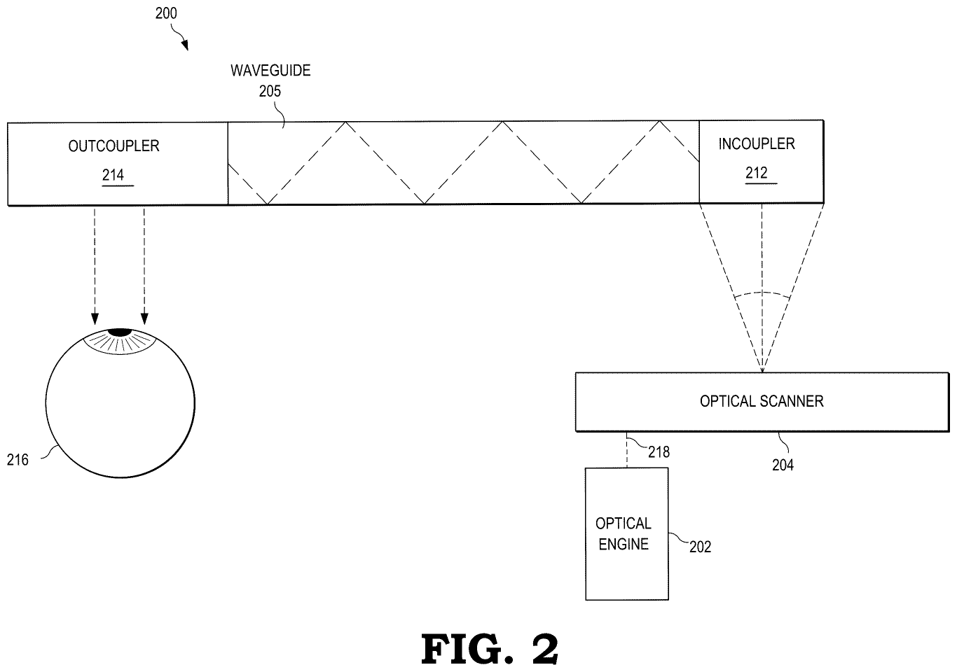

FIG. 2 illustrates a simplified block diagram of a laser projection system 200 that projects images directly onto the eye of a user via laser light. The laser projection system 200 includes an optical engine 202, an optical scanner 204, and a waveguide 205. In some embodiments, the laser projection system 200 is implemented in a wearable heads-up display or other display systems, such as the display system 100 of FIG. 1.

The optical engine 202 includes one or more laser light sources configured to generate and output laser light 218 (e.g., visible laser light such as red, blue, and green laser light, non-visible laser light such as infrared laser light, or both). In some embodiments, the optical engine 202 is coupled to a driver or other controller (not shown for clarity), which controls the timing of emission of laser light from the laser light sources of the optical engine 202 in accordance with instructions received by the controller or driver from a computer processor coupled thereto to modulate the laser light 218 to be perceived as images when output to the retina of an eye 216 of a user. For example, during the operation of the laser projection system 200, multiple laser light beams having respectively different wavelengths are output by the laser light sources of the optical engine 202, then combined via a beam combiner (not shown), before being directed to the eye 216 of the user. The optical engine 202 modulates the respective intensities of the laser light beams so that the combined laser light reflects a series of pixels of an image, with the particular intensity of each laser light beam at any given point in time contributing to the amount of corresponding color content and brightness in the pixel being represented by the combined laser light at that time. According to embodiments, the optical engine 202 is configured to polarize at least a portion of the laser light beams before they are emitted by the optical engine 202. For example, optical engine 202 includes one or more wave plates (e.g., quarter-wave plates, half-wave plates) configured to polarize one or more laser light beams such that the laser light beams (e.g., the laser light emitted by optical engine 202) each have a first predetermined polarization (e.g., S-polarization, P-polarization).

In embodiments, the optical engine 202 is configured to provide emitted laser light 218 to an optical scanner 204. The optical scanner 204 is configured to receive laser light 218 and scan laser light 218 in one or more directions toward incoupler 212 of waveguide 205. To this end, the optical scanner 204 includes one or more scan mirrors (e.g., MEMS mirrors) configured to scan received light in one or more directions (e.g., about one or more axes) and one or more optics relays configured to relay received light to a second point (e.g., incoupler 212). As an example, optical scanner 204 includes one or more MEMS mirrors that are driven by respective actuation voltages to oscillate in one or more directions (e.g., about one or more axes) during active operation of the laser projection system 200, causing the MEMS mirrors to scan the laser light 218 in one or more directions. Additionally, the optical scanner 204 includes one or more optical relays each including lenses, reflectors, or both configured to relay scanned light from a first scan mirror to a second scan mirror, relay scanned light from a scan mirror to incoupler 212, or both. For example, an optical relay includes a reflective relay, 2F relay, 4F relay, or any combination thereof configured to relay scanned light from a first scan mirror to a second scan mirror, incoupler 212, or both. In embodiments, an optical relay of the optical scanner 204 includes a line-scan relay configured to, for example, receive light scanned in one or more directions from a first scan mirror and relay the scanned light to a second scan mirror, the incoupler 212, or both such that the scanned light converges in the one or more directions to an exit pupil beyond the second scan mirror, the incoupler 212, or both. An exit pupil in an optical system, for example, refers to the location along the optical path where beams of light intersect. According to embodiments, the width (e.g., smallest dimension) of a given exit pupil approximately corresponds to the diameter of the laser light corresponding to that exit pupil. According to embodiments, the optical relay of the optical scanner 204 includes, for example, one or more collimation lenses that shape and focus scanned light in one or more directions received from a first mirror on to a second scan mirror, the incoupler 212, or both. As another example, the optical relay includes one or more molded reflective relays that each includes two or more spherical, aspheric, parabolic, freeform lenses, or any combination thereof, that shape and direct scanned light in one or more directions from a first mirror onto a second scan mirror, the incoupler 212, or both.

In some embodiments, the optical engine 202 includes an edge-emitting laser (EEL) that emits a laser light 218 having a substantially elliptical, non-circular cross-section, and the optical scanner includes 204 includes an optical relay configured to magnify or minimize the laser light 218 along its semi-major or semi-minor axis to circularize the laser light 218 prior to convergence of the laser light 218 on a scan mirror, incoupler 212, or both. In some such embodiments, a surface of a mirror plate of a scan mirror is elliptical and non-circular (e.g., similar in shape and size to the cross-sectional area of the laser light 218). In other such embodiments, the surface of the mirror plate of the scan mirror is circular.

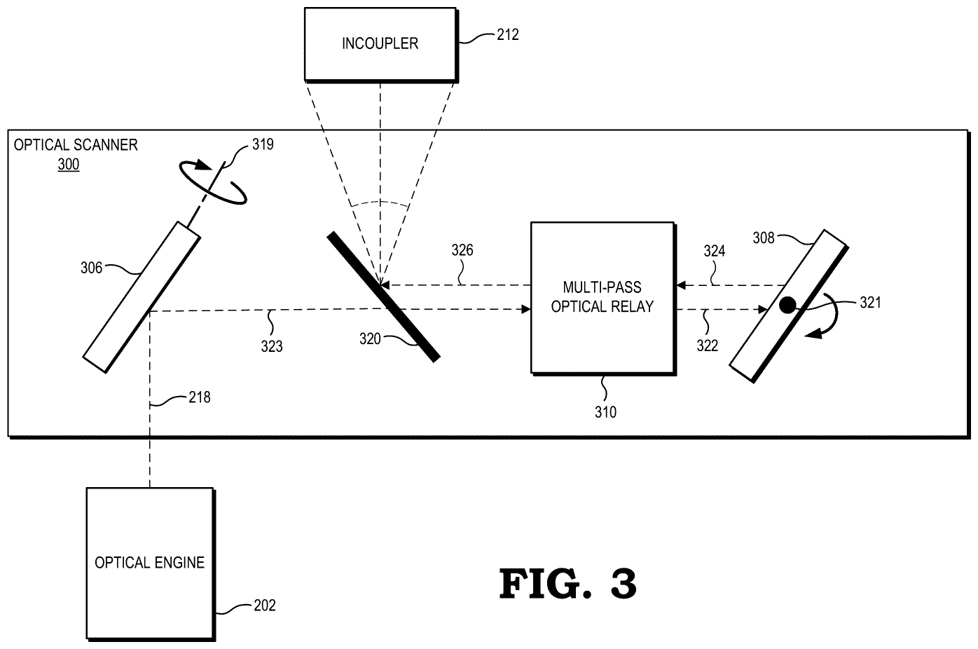

To scan received light in two directions, some embodiments of the optical scanner 204 include one or more scan mirrors (e.g., MEMS mirrors) configured to oscillate in two directions (e.g., 2-D mirrors) such that received light is scanned in two directions before being provided to incoupler 212 (e.g., via an optical relay). However, such optical scanners 204 including 2-D mirrors (e.g., scan mirrors configured to oscillate in two directions) are large in size, increasing the form factor of a WHUD (e.g., a WHUD including display system 100) and making it difficult for the WHUD to achieve the form factor and fashion appeal expected of eyeglasses and sunglasses. Additionally, to scan received light in two directions, other embodiments of the optical scanner 204 include two or more scan mirrors (e.g., MEMS mirrors) configured to oscillate in one direction (e.g., 1D mirrors) and two or more optical relays to respectively relay scanned light between the scan mirrors and to relay the scanned light to the incoupler 212. However, due to the physical separation of the 1-D scan mirrors, the exit pupil position of the scanned light along a first axis is different from the exit pupil position along one or more other axes (e.g., the physical separation of the two or more 1-D scan mirrors causes a pupil walk in the scanned light). The difference in the exit pupil position along the axes of the scanned light results in the scanned light having a rectangular or oval shape when it is provided to the incoupler 212 by an optical relay rather than a circular or square shape. To help reduce the size of an optical scanner 204 configured to scan light in two or more directions without introducing pupil walk, the optical scanner 204 includes a multi-pass optical relay. For example, and as discussed in detail below with reference to FIG. 3, the optical scanner 204 includes two 1D scan mirrors (e.g., 1D MEMS mirrors) and a multi-pass optical relay configured to both relay light from a first 1D scan mirror to a second 1D scan mirror and from the second 1D scan mirror to the incoupler 212. That is to say, the optical scanner 204 includes a multi-pass optical relay configured to relay scanned light from a first 1D scan mirror to a second 1-D scan mirror and scanned light from the second 1-D scan mirror to the incoupler 212.

The waveguide 205 of the laser projection system 200 includes the incoupler 212 and the outcoupler 214. The term “waveguide,” as used herein, will be understood to mean a combiner using one or more of total internal reflection (TIR), specialized filters, and/or reflective surfaces, to transfer light from an incoupler (such as the incoupler 212) to an outcoupler (such as the outcoupler 214). In some display applications, the light is a collimated image, and the waveguide transfers and replicates the collimated image to the eye. In general, an incoupler and outcoupler each include, for example, one or more optical grating structures, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the laser light 218 received at the incoupler 212 is relayed to the outcoupler 214 via the waveguide 205 using TIR. The laser light 218 is then output to the eye 216 of a user via the outcoupler 214. As described above, in some embodiments the waveguide 205 is implemented as part of an eyeglass lens, such as the lens 108 or lens 110 (FIG. 1) of the display system having an eyeglass form factor and employing the laser projection system 200.

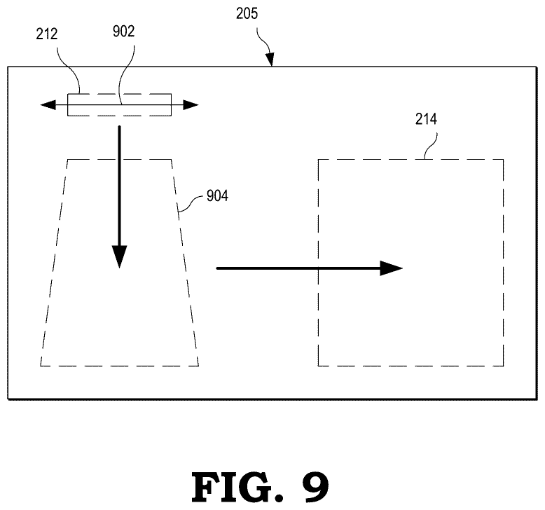

Although not shown in the example of FIG. 2, in some embodiments additional optical components are included in any of the optical paths between the optical engine 202 and the optical scanner 204, optical paths within the optical scanner 204 (e.g., between two or more scan mirrors, between a scan mirror and an optical relay), optical paths between the optical scanner 204 and the incoupler 212, optical paths between the incoupler 212 and the outcoupler 214, optical paths between the outcoupler 214 and the eye 216 (e.g., in order to shape the laser light for viewing by the eye 216 of the user), or any combination thereof. For example, in some embodiments, a beam splitter is used to steer light from a scan mirror or optical relay of the optical scanner 204 into the incoupler 212 so that light is coupled into the incoupler 212 at the appropriate angle to encourage propagation of the light in waveguide 205 by TIR. Also, in some embodiments, an exit pupil expander (e.g., an exit pupil expander 904 of FIG. 9, described below), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 216 of the user).

Referring now to FIG. 3, optical scanner 300 including a multi-pass optical relay is presented. In embodiments, optical scanner 300, similar to or the same as optical scanner 204, is configured to receive laser light 218 emitted from optical engine 202. In response to receiving laser light 218, optical scanner 300 is configured to scan laser light 218 in two directions (e.g., about two axes) and provide the scanned light 323 (e.g., light scanned in two directions) to incoupler 212. To this end, optical scanner 300 includes a first scan mirror 306 (e.g., MEMS mirror) configured to receive laser light 218. First scan mirror 306 is configured to oscillate along first scanning axis 319 such that laser light 218 is scanned in only one direction (e.g., in a line) across the surface of a second scan mirror 308. Further, first scan mirror 306 is configured to provide scanned light 323 to beam splitter 320. Beam splitter 320 includes, for example, one or more plate beam splitters, cube beam splitters, polarizing beam splitters, prisms, or any combination thereof configured to transmit light having a first predetermined polarization, first predetermined angle of incidence (e.g., with respect to a surface of beam splitter 320), or both and reflect light having a second predetermined polarization, second predetermined angle of incidence (e.g., with respect to a surface of beam splitter 320), or both. As an example, beam splitter 320 includes a polarizing beam splitter (e.g., polarizing plate beam splitter, a polarizing cube beam splitter) configured to transmit light having a first predetermined polarization (e.g., S polarization) and reflect light having a second predetermined polarization (e.g., P polarization). In embodiments, beam splitter 320 is configured to transmit scanned light 323 having a first predetermined polarization, a first predetermined angle of incidence, or both to multi-pass optical relay 310. For example, beam splitter 320 is configured to transmit at least a portion of scanned light 323 having a first predetermined polarization, a first predetermined angle of incidence, or both to multi-pass optical relay 310.

Multi-pass optical relay 310 includes an optical relay configured to both relay light between scan mirrors (e.g., from a first scan mirror to a second scan mirror) and relay light from a scan mirror to incoupler 212 of waveguide 205. To this end, multi-pass optical relay 310 includes one or more lenses (e.g., collimation lenses), reflective relays, line-scan relays, or any combination thereof configured to relay scanned light 323 from first scan mirror 306, beam splitter 320, or both to a second scan mirror 308 as laser light 322. For example, multi-pass optical relay 310 includes one or more one or more lenses (e.g., collimation lenses), reflective relays, or both configured to relay scanned light 323 such that laser light 322 focuses in a first direction (e.g., the direction of first scanning axis 319) on second scan mirror 308. Second scan mirror 308 (e.g., MEMS mirror) is configured to oscillate along second scanning axis 321 such that laser light 322 is scanned in a second direction (e.g., in a line) across incoupler 212. In some embodiments, first scanning axis 319 is perpendicular to the second scanning axis 321. Further, second scan mirror 308 is configured to provide the laser light scanned in two directions (e.g., laser light 324) back to multi-pass optical relay 310. Multi-pass optical relay 310 is configured to relay laser light 324 (e.g., laser light scanned in two directions) to beam splitter 320 as relayed light 326. For example, multi-pass optical relay 310 is configured to relay laser light 324 to beam splitter 320 such that relayed light 326 focuses in two directions (e.g., first scanning axis 319 and second scanning axis 321) at incoupler 212. Beam splitter 320 is configured to reflect relayed light 326 having a second predetermined polarization, a second predetermined angle of incidence, or both toward incoupler 212. For example, optical scanner 300 includes one or more waveplates (e.g., quarter-wave plates) configured to change the polarization of light as it travels through optical scanner 300 such that relayed light 326 has a second predetermined polarization. Beam splitter 320 is then configured to reflect at least a portion of relayed light 326 having the second predetermined polarization to incoupler 212. In this way, the multi-pass optical relay allows optical scanner 300 to scan laser light 218 in two directions while reducing the size of optical scanner 300 and helping reduce pupil walk of relayed light 326. As such, a WHUD including optical scanner 300 achieves the form factor and fashion appeal expected of eyeglasses and sunglasses.

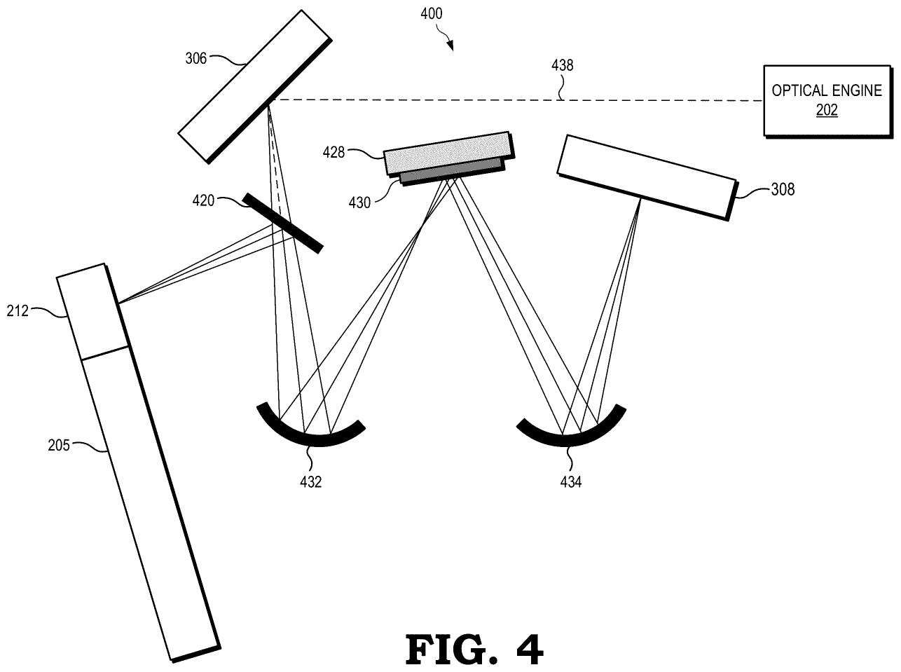

Referring now to FIGS. 4 to 8, respective example embodiments of an optical scanner including a multi-pass optical relay and configured to scan laser light from optical engine 202 to incoupler 212 of waveguide 205 are presented. For example, FIG. 4 presents an optical scanner 400, similar to or the same as optical scanner 204, 300, including first scan mirror 306, second scan mirror 308, polarizing beam splitter (PBS) 420, and a multi-pass optical relay including reflectors 432, 434, fold mirror 428, and wave plate (e.g., quarter-wave plate) 430. Still referring to the example embodiment illustrated in FIG. 4, optical engine 202 emits laser light 438 towards first scan mirror 306. In embodiments, laser light 438 received at first scan mirror 306 is polarized in a first direction (e.g., P-polarization). In response to receiving laser light 438, first scan mirror 306 is configured to scan laser light 438 in a first direction and provide the scanned laser light 438 to PBS 420. PBS 420 is configured to transmit at least a portion of scanned laser light 438 having a first predetermined polarization (e.g., P-polarization, S-polarization) towards reflector 432. For example, PBS 420 is configured to transmit scanned laser light 438 having a first predetermined polarization (e.g., P-polarization) towards reflector 432.

Reflectors 432, 434 each include one or more reflective surfaces configured to reflect received light such that it converges at a second point. As an example, reflectors 434, 434 each include one or more spherical lenses, aspheric lenses, parabolic lenses, freeform lenses, or any combination thereof configured to reflect received light such that it converges at a second point. According to embodiments, reflector 432 is configured to receive scanned laser light 438 from PBS 420. As an example, reflector 432 receives laser light 438 having a first predetermined polarization (e.g., P-polarization) from PBS 420. In response to receiving scanned laser light 438 from PBS 420, reflector 432 reflects scanned laser light 438 towards fold mirror 428 such that the reflected laser light 438 converges at point between reflector 432 and fold mirror 428. Fold mirror 428 includes, for example, one or more surfaces (e.g., one or more folds) configured to reflect received light such that the length of an optical path (e.g., length of the optical path in optical scanner 400) is increased. In this way, fold mirror 428 increases the length of the optical path of optical scanner 400 without increasing the physical length of optical scanner 400. In response to receiving scanned laser light 438, fold mirror 428 is configured to reflect scanned laser light 438 towards reflector 434.

In embodiments, wave plate 430 is disposed on or proximate to a surface of fold mirror 428. For example, wave plate 430 is disposed on or proximate to a surface of fold mirror 428 such that light received at fold mirror 428 is polarized by wave plate 430. In embodiments, wave plate 430 is a quarter-wave plate configured to circularly polarize received light. As an example, fold mirror 428 is configured to receive scanned laser light 438 having a first predetermined polarization (e.g., P-polarization) from reflector 432. As scanned laser light 438 passes through wave plate 430 (e.g., a quarter-wave plate) before being received by fold mirror 428, wave plate 430 is configured to circularly polarize scanned laser light 438 such that scanned laser light 438 has a circular polarization based on the first predetermined polarization of scanned laser light 438.

In response to receiving scanned laser light 438 from fold mirror 428, reflector 434 is configured to reflect scanned laser light 438 towards second scan mirror 308 such that scanned laser light 438 converges at second scan mirror 308. In response to receiving scanned laser light 438, second scan mirror 308 is configured to scan the scanned laser light 438 in a second direction (e.g., a second direction perpendicular to the first direction of the first scan mirror) such that laser light 438 is scanned in two directions (e.g., twice-scanned laser light 438). Second scan mirror 308 is configured to scan scanned laser light 438 back towards reflector 434. In response to receiving twice-scanned laser light 438, reflector 434 is configured to reflect twice-scanned laser light back towards fold mirror 428. For example, reflector 434 is configured to reflect twice-scanned laser light 438 back towards fold mirror 428 such that twice-scanned laser light 438 converges at a point beyond fold mirror 428. As twice-scanned laser light 438 is received by fold mirror 428, twice-scanned laser light 438 first passes through wave plate 430. In embodiments, wave plate 430 (e.g., a quarter-wave plate) is configured to circularly polarize twice-scanned laser light 438 such that twice-scanned laser light 438 has a second predetermined polarization that is perpendicular to the first predetermined polarization. As an example, wave plate 430 (e.g., a quarter-wave plate) polarizes scanned laser light 438 (e.g., having a first predetermined polarization) such that scanned laser light 438 has a circular polarization before being reflected off fold mirror 428 and reflector 434 and received at second scan mirror 308. Second scan mirror 308 then scans laser light 438 in a second direction such that twice-scanned laser light 438, having a circular polarization, is reflected off reflector 434 and passes through wave plate 430. As twice-scanned laser light 438 passes through wave plate 430, wave plate 430 circularly polarizes twice-scanned laser light 438 such that twice-scanned laser light 438 has a second predetermined polarization (e.g., S-polarization) perpendicular to the first predetermined polarization.

In response to receiving twice-scanned laser light 438 (e.g., having a second predetermined polarization), fold mirror 428 reflects twice-scanned laser light 438 towards reflector 432. Reflector 432 is configured to reflect twice-scanned laser light 438 towards PBS 420 such that twice-scanned laser light 438 converges at a point beyond PBS 420 (e.g., incoupler 212 of waveguide 205). In response to receiving, twice-scanned laser light 438, PBS 420 is configured to reflect at least a portion of twice-scanned laser light 438 having a second predetermined polarization towards incoupler 212. For example, PBS 420 reflects twice-scanned laser light 438 having a second predetermined polarization due to wave plate 430 toward incoupler 212 of waveguide 205.

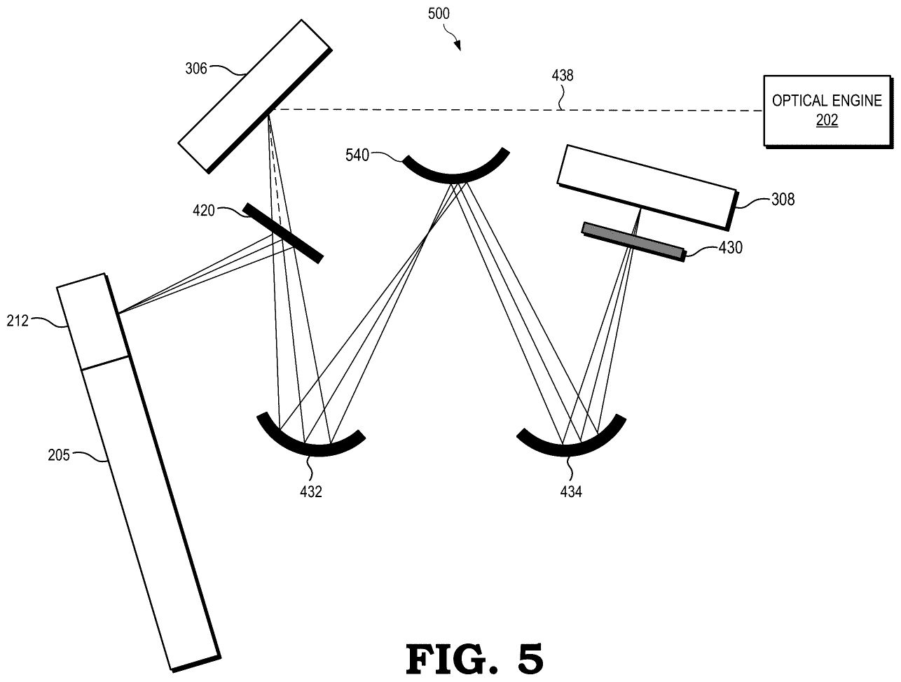

Referring now to FIG. 5, an optical scanner 500, similar to or the same as optical scanner 204, 300, including first scan mirror 306, second scan mirror 308, PBS 420, and a multi-pass optical relay including reflectors 432, 434, 540, and wave plate 430 is presented. In embodiments, laser light 438 emitted from optics engine 202 is received by first scan mirror 306 configured to scan laser light 438 in a first direction. First scan mirror 306 provides scanned laser light 438 to PBS 420 configured to transmit scanned laser light 438 having a first predetermined polarization (e.g., P-polarization) towards reflector 432. Reflector 432 then reflects scanned laser light 438 towards reflector 540 such that scanned laser light 438 converges at a point between reflectors 432, 540. Reflector 540 includes one or more lenses (e.g., spherical, aspheric, parabolic, freeform lenses) configured to reflect received light towards reflector 434. For example, reflector 540 includes one or more lenses configured to reflect scanned laser light 438 towards reflector 434. By using reflector 540 to reflect scanned laser light 438 towards reflector 434, the number of angles at which to reflect scanned laser light 438 within optical scanner 500 is increased, better allowing optical scanner 500 to achieve a smaller size.

In response to receiving scanned laser light 438 from reflector 540, reflector 434 is configured to reflect scanned laser light 438 toward second scan mirror 308 such that scanned laser light 438 converges at second scan mirror 308. According to embodiments, wave plate 430 (e.g., a quarter-wave plate) is disposed in the optical path between reflector 434 and second scan mirror 308. As scanned laser light 438 (e.g., having a first predetermined polarization) passes through wave plate 430 (e.g., a quarter-wave plate), wave plate 430 circularly polarized scanned laser light 438 such that scanned laser light 438 has a circular polarization based on the first predetermined polarization before being received by second scan mirror 308. In response to receiving scanned laser light 438 (e.g., having a circular polarization), second scan mirror 308 scans scanned laser light 438 in a second direction (e.g., producing twice-scanned laser light 438) back towards reflector 434. As twice scanned laser light 438 (e.g., having a circular polarization) passes through wave plate 430 (e.g., a quarter-wave plate) on its way to reflector 434, wave plate 430 circularly polarizes twice-scanned laser light 438 such that twice-scanned laser light has a second predetermined polarization perpendicular to the first predetermined polarization. After receiving twice-scanned laser light 438, reflector 434 reflects twice-scanned laser light 438 towards reflector 540 such that twice-scanned laser light 438 converges at a point beyond reflector 540. Reflector 540 then reflects twice-scanned laser light 438 toward reflector 432 configured to reflect twice-scanned laser light 438 toward PBS 420 such that twice-scanned laser light 438 converges at a point beyond PBS 420 (e.g., at incoupler 212). In response to receiving twice-scanned laser light 438, PBS 420 reflects at least a portion of twice-scanned laser light 438 having a second predetermined polarization (e.g., due to wave plate 430) toward incoupler 212.

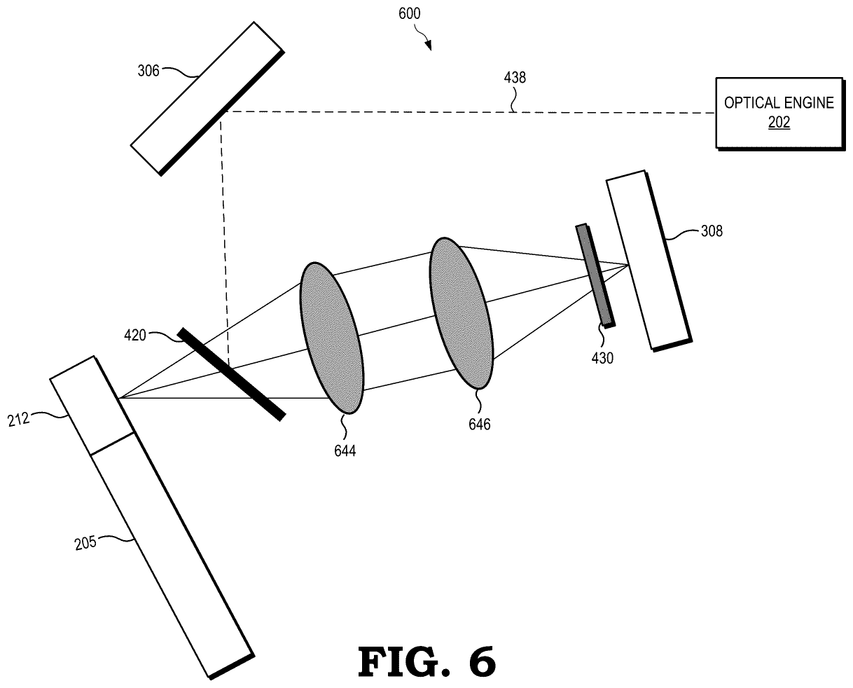

Referring now to FIG. 6, an optical scanner 600, similar to or the same as optical scanners 204, 300, including first scan mirror 306, second scan mirror 308, PBS 420, and a multi-pass optical relay including lenses 644, 646 and wave plate 430 is presented. In embodiments, first scan mirror 306 receives laser light 438 (e.g., having a first predetermined polarization) emitted from optical engine 202. In response to receiving laser light 438, first scan mirror 306 scans laser light 438 in a first direction toward PBS 420. In response to receiving scanned laser light 438, PBS 420 reflects at least a portion of scanned laser light 438 having a first predetermined polarization towards lens 644 of a multi-pass optical relay. For example, PBS 420 reflects scanned laser light 438 having a first predetermined polarization toward lens 644. Lenses 644, 646 each include one or more optical lenses (e.g., positive lenses) together forming, for example, a 2F relay, 4F relay, or both. In response to receiving scanned laser light 438, lens 644 is configured to transmit scanned laser light 438 to lens 646 which, in turn, transmits scanned laser light 438 toward second scan mirror 308. In embodiments, light transmits through lenses 644, 646 such that the transmitted light converges at a point based on the properties of lenses 644, 646, the positioning of lenses 644, 646, or both. For example, scanned laser light 438 passes through lenses 644, 646 (e.g., together forming a 4F relay) such that scanned laser light 438 converges at second scan mirror 308.

According to embodiments, wave plate 430 (e.g., a quarter-wave plate) is disposed in the optical path between lens 646 and second scan mirror 308. In this way, wave plate 430 (e.g., a quarter-wave plate) is configured to circularly polarize light transmitted by lens 646 before the light is received at second scan mirror 308. For example, scanned laser light 438 (e.g., having a first predetermined polarization) transmitted from lens 646 is received by wave plate 430 (e.g., a quarter-wave plate). In response to receiving scanned laser light 438, wave plate 430 is configured to circularly polarize scanned laser light 438 such that scanned laser light 438 has a circular polarization based on, for example, the first predetermined polarization. In response to receiving scanned laser light 438 (e.g., having a circular polarization), second scan mirror 308 is configured to scan scanned laser light 438 in a second direction (e.g., producing twice-scanned laser light 438) toward lens 646. As twice-scanned laser light 438 (e.g., having a circular polarization) passes through wave plate 430 (e.g., a quarter-wave plate) before being received by lens 646, wave plate 430 circularly polarizes twice-scanned laser light 438 such that twice-scanned laser light 438 has a second predetermined polarization perpendicular to the first predetermined polarization. In response to receiving twice-scanned laser light 438 (e.g., having a second predetermined polarization), lens 646 transmits twice-scanned laser light 438 to lens 644 which transmits twice-scanned laser light 438 (e.g., having a second predetermined polarization) to PBS 420. In embodiments, lenses 644, 646 are together configured to transmit twice-scanned laser light 438 to PBS 420 such that twice-scanned laser light 438 converges at a point past twice-scanned laser light 438, for example, incoupler 212. PBS 420 is configured to transmit twice-scanned laser light 438 having a second predetermined polarization (e.g., due to wave plate 430) to incoupler 212.

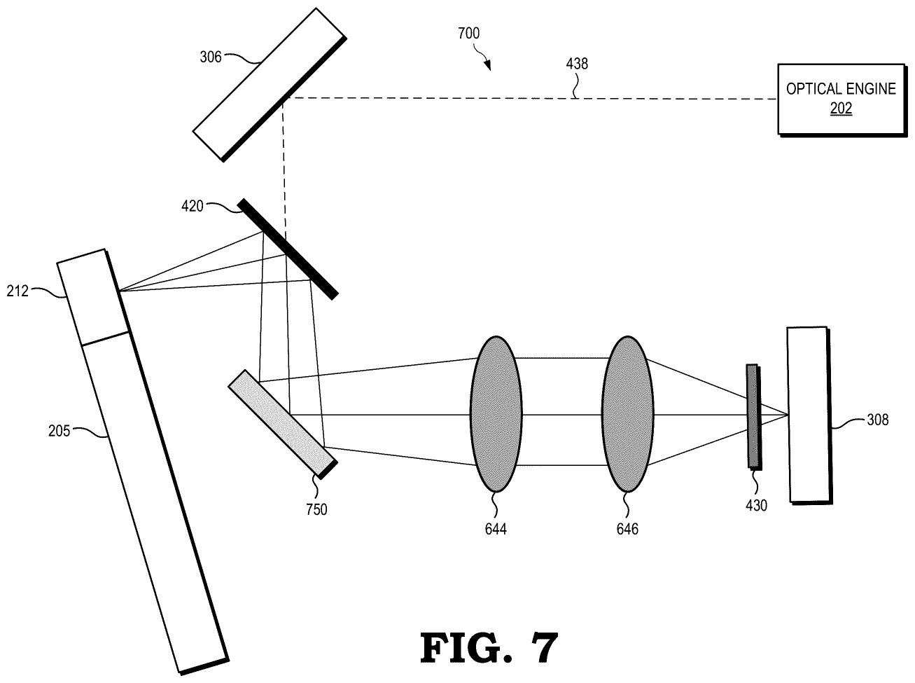

Referring now to FIG. 7, an optical scanner 700, similar to or the same as optical scanners 204, 300, including first scan mirror 306, second scan mirror 308, PBS 420, and a multi-pass optical relay including lenses 644, 646, fold mirror 750, and wave plate 430 is presented. In embodiments, first scan mirror 306 receives laser light 438 (e.g., having a first predetermined polarization) emitted from optical engine 202. In response to receiving laser light 438, first scan mirror 306 scans laser light 438 in a first direction toward PBS 420. In response to receiving scanned laser light 438, PBS 420 reflects at least a portion of scanned laser light 438 having a first predetermined polarization towards fold mirror 750, similar to or the same as fold mirror 428. Fold mirror 750 includes, for example, one or more surfaces (e.g., one or more folds) configured to reflect received light such that the length of an optical path (e.g., length of the optical path in optical scanner 700) is increased. In response to receiving scanned laser light 438, fold mirror 750 is configured to reflect scanned laser light 438 toward lens 644. In response to receiving scanned laser light 438, lens 644 is configured to transmit scanned laser light 438 to lens 646 which, in turn, transmits scanned laser light 438 toward second scan mirror 308. In embodiments, light transmits through lenses 644, 646 such that the transmitted light converges at a point based on the properties of lenses 644, 646, the positioning of lenses 644, 646, or both. For example, scanned laser light 438 passes through lenses 644, 646 (e.g., together forming a 4F relay) such that scanned laser light 438 converges at second scan mirror 308.

According to embodiments, wave plate 430 (e.g., a quarter-wave plate) is disposed in the optical path between lens 646 and second scan mirror 308. In this way, wave plate 430 (e.g., a quarter-wave plate) is configured to circularly polarize light transmitted by lens 646 before the light is received at second scan mirror 308. For example, scanned laser light 438 (e.g., having a first predetermined polarization) transmitted from lens 646 is received by wave plate 430 (e.g., a quarter-wave plate). In response to receiving scanned laser light 438, wave plate 430 is configured to circularly polarize scanned laser light 438 such that scanned laser light 438 has a circular polarization based on, for example, the first predetermined polarization. In response to receiving scanned laser light 438 (e.g., having a circular polarization), second scan mirror 308 is configured to scan scanned laser light 438 in a second direction (e.g., producing twice-scanned laser light 438) toward lens 646. As twice-scanned laser light 438 (e.g., having a circular polarization) passes through wave plate 430 (e.g., a quarter-wave plate) before being received by lens 646, wave plate 430 circularly polarizes twice-scanned laser light 438 such that twice-scanned laser light 438 has a second predetermined polarization perpendicular to the first predetermined polarization. In response to receiving twice-scanned laser light 438 (e.g., having a second predetermined polarization), lens 646 transmits twice-scanned laser light 438 to lens 644 which transmits twice-scanned laser light 438 (e.g., having a second predetermined polarization) to fold mirror 750 which reflects twice-scanned laser light 438 to PBS 420. In embodiments, lenses 644, 646 are together configured to transmit twice-scanned laser light 438 to fold mirror 750 such that twice-scanned laser light 438 converges at a point past PBS 420, for example, incoupler 212. PBS 420 is configured to transmit twice-scanned laser light 438 having a second predetermined polarization (e.g., due to wave plate 430) to incoupler 212. Using fold mirror 750 to reflect laser light 438 toward and away from PBS 420 allows optical scanner 700 to orient along different axes, helping optical scanner 700 achieve a smaller size.

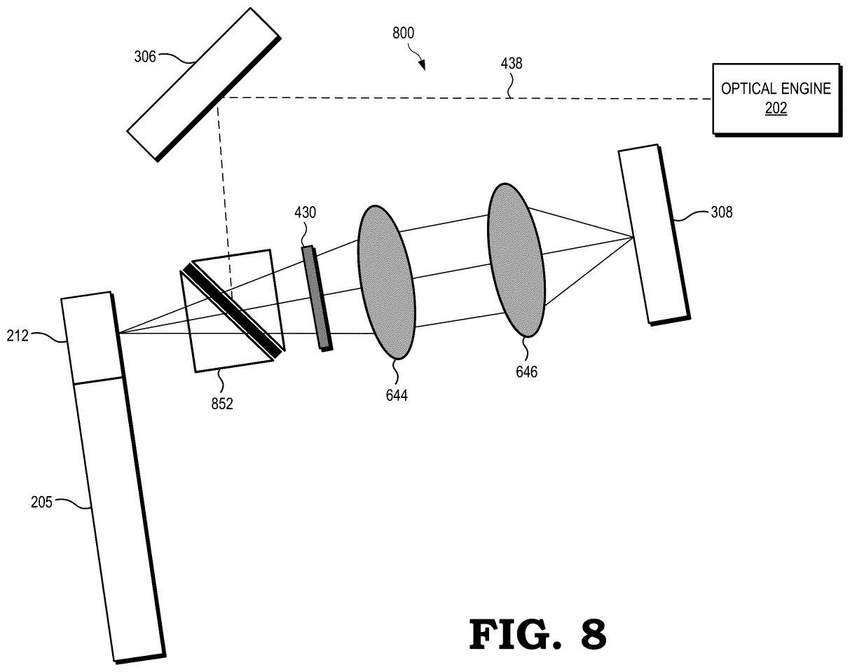

Referring now to FIG. 8, an optical scanner 800, similar to or the same as optical scanners 204, 300, including first scan mirror 306, second scan mirror 308, cube beam splitter 852, and a multi-pass optical relay including lenses 644, 646, and wave plate 430 is presented. In embodiments, first scan mirror 306 receives laser light 438 (e.g., having a first predetermined polarization) emitted from optical engine 202. In response to receiving laser light 438, first scan mirror 306 scans laser light 438 in a first direction toward cube beam splitter 852 configured to reflect light having a first predetermined angle of incidence, first predetermined polarization, or both and transmit light having a second predetermined angle of incidence, second predetermined polarization, or both. For example, cube beam splitter 852 is configured to reflect at least a portion of scanned laser light 438 having a first predetermined polarization toward lens 644. In embodiments, wave plate 430 (e.g., a quarter-wave plate) is disposed in the optical path between cube beam splitter 852 and lens 644. As scanned laser light 438 (e.g., having a first predetermined polarization) is reflected from cube beam splitter 852 toward lens 644, scanned laser light 438 is first received by wave plate 430. Wave plate 430 (e.g., a quarter-wave plate) is configured to circularly polarize scanned laser light 438 such that scanned laser light 438 has a circular polarization, for example, based on the first predetermined polarization. In response to receiving scanned laser light 438 (e.g., having a circular polarization), lens 644 transmits scanned laser light 438 to lens 646 which transmits scanned laser light 438 to second scan mirror 308. In embodiments, lenses 644, 646 are together configured to transmit scanned laser light 438 to second scan mirror 308 such that scanned laser light 438 converges at second scan mirror 308.

In response to receiving scanned laser light 438, second scan mirror 308 scans scanned laser light 438 in a second direction (e.g., producing twice-scanned laser light 438) back toward lens 646. Lens 646 is configured to transmit twice-scanned laser light 438 to lens 644 which is configured to transmit twice-scanned laser light 438 to cube beam splitter 852. According to embodiments, lenses 644, 646 are together configured to transmit twice-scanned laser light 438 to cube beam splitter 852 such that twice-scanned laser light 438 converges at a point past cube beam splitter 852, for example incoupler 212. Before twice-scanned laser light 438 (e.g., having a circular polarization) is received at cube beam splitter 852, twice-scanned laser light 438 passes through wave plate 430 (e.g., a quarter-wave plate). Wave plate 430 is configured to circularly polarize twice-scanned laser light 438 such that twice-scanned laser light 438 has a second predetermined polarization perpendicular to the first predetermined polarization. In response to receiving twice-scanned laser light 438 (e.g., having the second predetermined polarization), cube beam splitter is configured to transmit at least a portion of twice-scanned laser light 438 having the second predetermined polarization towards incoupler 212.

FIG. 9 shows an example of light propagation within the waveguide 205 of the laser projection system 200 of FIG. 2 in accordance with some embodiments. As shown, light received via the incoupler 212, which is scanned along the scanning axis 902, is directed into an exit pupil expander (EPE) 904 and is then routed to the outcoupler 214 to be output (e.g., toward the eye of the user). In some embodiments, the exit pupil expander 904 expands one or more dimensions of the eyebox of a WHUD that includes the laser projection system 200 (e.g., with respect to what the dimensions of the eyebox of the WHUD would be without the exit pupil expander 904). In some embodiments, the incoupler 212, the exit pupil expander 904, and the outcoupler 214 each include respective one-dimensional diffraction gratings (i.e., diffraction gratings that extend along one dimension). It should be understood that FIG. 9 shows a substantially ideal case in which the incoupler 212 directs light straight down (with respect to the presently illustrated view) in a first direction that is perpendicular to the scanning axis 902, and the exit pupil expander 904 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 902.

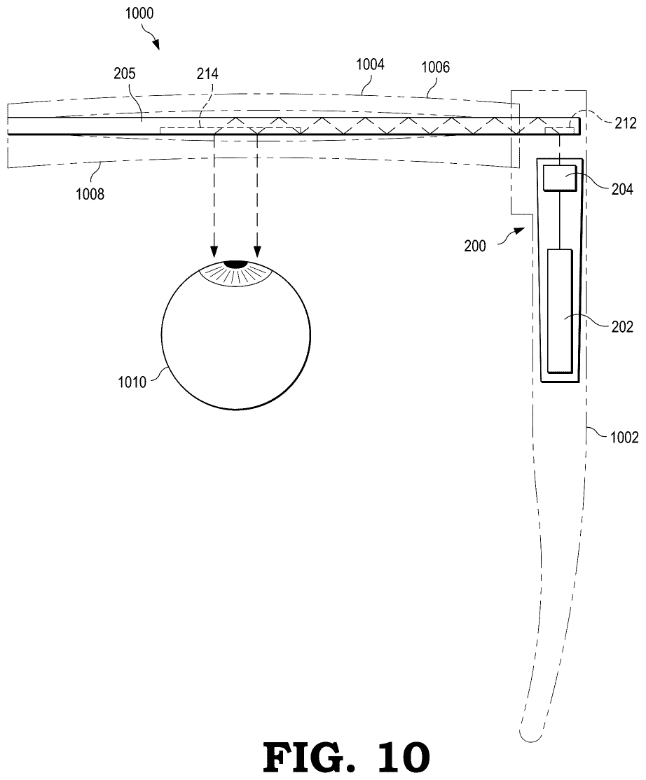

FIG. 10 illustrates a portion of a WHUD 1000 that includes optical scanner 204, optical scanner 300, optical scanner 400, optical scanner 500, optical scanner 600, optical scanner 700, optical scanner 800, or any combination thereof. In some embodiments, the WHUD 1000 represents the display system 100 of FIG. 1. The optical engine 202, the optical scanner (e.g., optical scanner 204, 300, 400, 500, 600, 700, 800), the incoupler 212, and a portion of the waveguide 205 are included in an arm 1002 of the WHUD 1000, in the present example.

The WHUD 1000 includes an optical combiner lens 1004, which includes a first lens 1006, a second lens 1008, and the waveguide 205, with the waveguide 205 disposed between the first lens 1006 and the second lens 1008. Light exiting through the outcoupler 214 travels through the second lens 1008 (which corresponds to, for example, the lens element 110 of the display system 100). In use, the light exiting second lens 1008 enters the pupil of an eye 1010 of a user wearing the WHUD 1000, causing the user to perceive a displayed image carried by the laser light output by the optical engine 202.

According to embodiments, the optical combiner lens 1004 is substantially transparent, such that light from real-world scenes corresponding to the environment around the WHUD 1000 passes through the first lens 1006, the second lens 1008, and the waveguide 205 to the eye 1010 of the user. In this way, images or other graphical content output by the laser projection system 200 are combined (e.g., overlayed) with real-world images of the user's environment when projected onto the eye 1010 of the user to provide an AR experience to the user.

Although not shown in the depicted example, in some embodiments additional optical elements are included in any of the optical paths between the optical engine 202 and the incoupler 212, in between the incoupler 212 and the outcoupler 214, and/or in between the outcoupler 214 and the eye 1010 of the user (e.g., in order to shape the laser light for viewing by the eye 1010 of the user). As an example, a prism is used to steer light from the optical scanner 204 into the incoupler 212 so that light is coupled into incoupler 212 at the appropriate angle to encourage propagation of the light in waveguide 205 by TIR. Also, in some embodiments, an exit pupil expander (e.g., the exit pupil expander 904), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the laser light out of waveguide 205 (e.g., toward the eye 1010 of the user).

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An optical scanner for a wearable heads-up display, comprising:
a first scan mirror configured to scan received light in a first direction;
a second scan mirror configured to scan received light in a second direction; and
a multi-pass optical relay configured to relay light scanned in the first direction from the first scan mirror to the second scan mirror and configured to relay light scanned in the first and second directions from the second scan mirror to an incoupler of a waveguide.

2. The optical scanner of claim 1, further comprising a polarizing beam splitter configured to reflect light having a first predetermined polarization toward the multi-pass optical relay and configured to transmit light having a second predetermined polarization toward the incoupler of the waveguide.

3. The optical scanner of claim 1, wherein the light scanned in the first direction has a first predetermined polarization.

4. The optical scanner of claim 3, further comprising a quarter-wave plate configured to polarize the light scanned in the first and second directions such that the light scanned in the first and second directions has a second predetermined polarization.

5. The optical scanner of claim 4, wherein the first predetermined polarization is perpendicular to the second predetermined polarization.

6. The optical scanner of claim 4, wherein the quarter-wave plate is disposed in an optical path between the multi-pass optical relay and the second scan mirror.

7. The optical scanner of claim 4, wherein the quarter-wave plate is disposed in an optical path between the first scan mirror and the multi-pass optical relay.

8. The optical scanner of claim 4, wherein the quarter-wave plate is disposed in the multi-pass optical relay.

9. The optical scanner of claim 1, wherein the multi-pass optical relay comprises a fold mirror configured to reflect light from a first lens of the multi-pass optical relay to a second lens of the multi-pass optical relay.

10. The optical scanner of claim 1, wherein the multi-pass optical relay comprises a 4F relay.

11. The optical scanner of claim 1, wherein the multi-pass optical relay includes a reflective relay.

12. The optical scanner of claim 1, wherein the first scan mirror comprises a first micro-electro-mechanical systems (MEMS) mirror configured to oscillate in the first direction and the second scan mirror comprises a second MEMS mirror configured to oscillate in the second direction.

13. A wearable heads-up display (WHUD), comprising:
an optical engine configured to emit laser light;
an optical scanner configured to scan the laser light in a first direction and a second direction; and
an incoupler of a waveguide configured to receive the laser light scanned in the first and second directions;
wherein the optical scanner includes:
a first scan mirror configured to scan the laser light in the first direction;
a second scan mirror configured to scan the laser light in the second direction; and
a multi-pass optical relay configured to relay the laser light scanned in the first direction from the first scan mirror to the second scan mirror and configured to relay the laser light scanned in the first and second directions from the second scan mirror to the incoupler.

14. The WHUD of claim 13, further comprising an arm configured to carry the optical engine and the optical scanner.

15. The WHUD of claim 13, further comprising a polarizing beam splitter configured to transmit laser light having a first predetermined polarization toward the multi-pass optical relay and configured to reflect light having a second predetermined polarization toward the incoupler of the waveguide.

16. The WHUD of claim 13, wherein the laser light scanned in the first direction has a first predetermined polarization.

17. The WHUD of claim 16, further comprising a quarter-wave plate configured to polarize the light scanned in the first and second directions such that the light scanned in the first and second directions has a second predetermined polarization.

18. The WHUD of claim 17, wherein the first predetermined polarization is perpendicular to the second predetermined polarization.

19. The WHUD of claim 17, wherein the quarter-wave plate is disposed in an optical path between the multi-pass optical relay and the second scan mirror.

20. The WHUD of claim 17, wherein the quarter-wave plate is disposed in an optical path between the first scan mirror and the multi-pass optical relay.

21. The WHUD of claim 17, wherein the quarter-wave plate is disposed in the multi-pass optical relay.

22. The WHUD of claim 13, wherein the multi-pass optical relay comprises a 4F relay.

23. The WHUD of claim 13, wherein the multi-pass optical relay includes a reflective relay.

24. A method, comprising:
scanning, by a first scan mirror, laser light in a first direction;
relaying, by a multi-pass optical relay, laser light scanned in the first direction from the first scan mirror to a second scan mirror;
scanning, by the second scan mirror, laser light in a second direction; and
providing, by the multi-pass optical relay, laser light scanned in the first and second directions to an incoupler of a waveguide.

25. The method of claim 24, further comprising:
emitting, by an optical engine, the laser light toward the first scan mirror.

26. The method of claim 24, further comprising:
polarizing laser light received by the first scan mirror such that the laser light received by the first scan mirror has a first predetermined polarization.

27. The method of claim 26, further comprising:
reflecting, by a polarizing beam splitter, at least a portion of the laser light scanned in the first direction having the first predetermined polarization toward the multi-pass optical relay.

28. The method of claim 27, further comprising:
polarizing, by a quarter-wave plate, laser light scanned in the first and second directions such that the laser light scanned in the first and second directions has a second predetermined polarization perpendicular to the first predetermined polarization.

29. The method of claim 28, further comprising:
transmitting, by the polarizing beam splitter, at least a portion of the laser light scanned in the first and second directions having the second predetermined polarization toward the incoupler.

30. The method of claim 24, further comprising:
providing, by the waveguide, at least a portion of the light laser light scanned in the first and second directions to a lens of an optical combiner.
